(19) United States
(12) Patent Application Publication
(10) Pub. No.: US 2016/0319861 A1
(43) Pub. Date: Nov. 3, 2016

(54) ROLLER BEARING

(71) Applicant: SCHAEFFLER TECHNOLOGIES AG & Co. KG, Herzogenaurach (DE)

(72) Inventors: Manfred Kraus, Herzogenaurach (DE); Jorg Weber, Forchheim (DE)

(73) Assignee: Schaeffler Technologies AG & Co. KG, Herzogenaurach (DE)

(21) Appl. No.: 15/108,680

(22) PCT Filed: Nov. 12, 2014
(86) PCT No.: PCT/DE2014/200630

§ 371 Date: Jun. 28, 2016

(30) Foreign Application Priority Data
Jan. 15, 2014 (DE) 102014200556.6
Aug. 6, 2014 (DE) 10 2014 215 523.1

(51) Int. Cl. F16C 19/18; F16C 19/50; F16C 33/58

(52) U.S. Cl. CPC F16C 19/18; F16C 33/583; F16C 19/505

(57) ABSTRACT

The invention relates to a rolling bearing having an inner race and an outer race. Between the inner race and the outer race, several rolling bodies are associated with at least one first bearing row between an inner raceway associated with the first bearing row and the outer raceway and several rolling bodies are associated with at least one second bearing row between an inner raceway associated with the second bearing row and the outer raceway. The at least one first bearing row is designed in such a way that several roller bodies are arranged at a distance from the inner raceway and/or the outer raceway of the bearing row when the inner race or outer race is stationary.

### BACKGROUND

The present invention relates to a rolling bearing with an inner ring and an outer ring. Between the inner ring and the outer ring, multiple rolling bodies of at least one first bearing row are allocated between an inner ring raceway and outer ring raceway allocated to the first bearing row and multiple rolling bodies of at least one second bearing row are allocated between an inner ring raceway and outer ring raceway allocated to the second bearing row.

Rolling bearings of the type specified above are well known from the prior art and common. The two bearing rows of the rolling bearing are always clamped from opposite sides so that rolling bodies are loaded with a preload even if no operating force is acting on them. In particular, such rolling bearings are used for supporting wheels. Here, the rolling bearing is then a two-row angled contact ball bearing in an O-arrangement.

One advantage of such constructions of this rolling bearing is that through the pretensioning of the two bearing rows, the wheel bearing is very stiff with respect to tipping (in comparison to non-pretensioned bearing rows). Tipping is produced, for example, by lateral forces when driving in curves. Due to this pretensioning, a higher tipping stiffness is achieved and thus a more stable driving behavior. This pretensioning, however, also produces a higher friction moment in the rolling bearing relative to non-pretensioned bearing rows. This results in a higher drive torque and thus a higher fuel consumption. In addition, driving straight ahead only rarely produces tipping forces requiring a significantly lower tipping stiffness. The cause for the increased friction moment results from the pretensioning of the two bearing rows. This is not required, however, while driving straight ahead, which accounts for a majority of the spectrum of load forces.

### SUMMARY

The object of the present invention is therefore to create a friction-reduced rolling bearing that has no pretensioning for use as a wheel bearing of a vehicle and simultaneously delivers the necessary tipping stiffness while driving in a curve.

This objective is achieved by a rolling bearing that comprises one or more of the features of the invention.

The rolling bearing according to the invention comprises an inner ring and an outer ring. Between the inner ring and the outer ring there are multiple rolling bodies of at least one first bearing row that are allocated between an inner ring raceway and outer ring raceway allocated to the first bearing row and multiple rolling bodies of at least one second bearing row that are allocated between an inner ring raceway and outer ring raceway allocated to the second bearing row.

According to the invention, the at least one first bearing row is constructed such that, for a stationary inner ring or outer ring, multiple rolling bodies have a distance to the inner ring raceway or the outer ring raceway of the bearing row.

A first preferred embodiment of the invention provides that, for a rotating inner ring, the inner ring raceway or the outer ring raceway of the at least first bearing row defines a raceway center point and the inner ring raceway or the outer ring raceway of the at least second bearing row defines a raceway center point, wherein both center points coincide with a rotational axis of the rolling bearing and wherein, for a stationary inner ring, the inner ring raceway or the outer ring raceway of the at least first bearing row defines a raceway center point that is radially offset relative to the raceway center point of the at least second bearing row.

Additional embodiments are then provided such that the inner ring and the outer ring of the at least first bearing row are arranged relative to each other such that a bearing gap, a loose fit, or the like determines the distance, called a radial clearance.

Instead of the construction of the radial clearance, an alternative embodiment provides that the outer ring raceway of the stationary outer ring of the at least first bearing row has an elliptical construction, so that just the distance described above is determined. Thus, namely the same effect as described for the embodiment above can be achieved.

In particular, the at least first bearing row of the rolling bearing according to the invention can be a single-row or multiple-row radial ball bearing, for example, a four-point, three-point, or angled contact ball bearing. Likewise, the at least first bearing row could also be a single-row or multiple-row radial rolling bearing, for example, a cylinder roller, needle, spherical, or ball joint bearing.

In another preferred embodiment of the rolling bearing according to the invention, the at least second bearing row is axially pretensioned. If the rolling bearing according to the invention is thus used in a wheel bearing, the at least first bearing row (there not at all or only slightly pretensioned) mainly absorbs the weight forces generated by the vehicle weight and the at least second bearing row then mainly absorbs the tipping moments produced from the lateral forces while driving in a curve. In an ideal case, the at least second bearing row then absorbs no forces when driving straight, and absorbs the lateral forces and the tipping moments generated by the lateral forces only when driving in a curve. Obviously, it is also because the lateral forces and tipping moments are absorbed according to the design of the rolling bearing according to the invention but also by the at least first bearing row or by a combination of the at least first and at least second bearing rows.

In another preferred embodiment of the rolling bearing according to the invention, at least one of the multiple rolling bodies of the at least second bearing row has an oversize so that the at least second bearing row is pretensioned. This pretensioning of the at least second bearing row is used by the introduction of rolling bodies with an oversize to prevent slip damage and to prevent increases in friction that are too high when starting to drive in a curve.

The at least second bearing row of the rolling bearing according to the invention can be a four-point bearing, a two-row angled contact ball bearing, a single-row or multiple-row radial ball bearing, a rolling bearing, a spherical or ball joint bearing, or a combination of a roller and radial ball bearing.

In another embodiment it is conceivable that a rolling body diameter of the at least second bearing row is smaller than a rolling body diameter of the at least first bearing row. Thus, for a rotating rolling bearing, the first bearing row defines a bearing center point and the second bearing row likewise defines a bearing center point that both coincide with a rotational axis of the rolling bearing.

### BRIEF DESCRIPTION OF THE DRAWINGS

Embodiments of the invention and their advantages with respect to the accompanying figures will be explained in more detail below. The size relationships in the figures do not always correspond to the real size relationships, because some shapes have been simplified and other shapes have been enlarged in relationship to other elements for better clarity in the drawing. Shown herein are:

FIG. 1 a schematic section view through the rolling bearing according to the invention with a first and a second bearing row,

FIG. 2 a schematic section view of another embodiment of a first or second bearing row of the rolling bearing according to the invention,

FIG. 3 a schematic section view of another embodiment of a first bearing row of the rolling bearing according to the invention,

FIG. 4 a schematic section view of another embodiment of a first bearing row of the rolling bearing according to the invention,

FIG. 5 a schematic section view of another embodiment of a second bearing row of the rolling bearing according to the invention,

FIG. 6 a schematic section view of another embodiment of a second bearing row of the rolling bearing according to the invention,

FIG. 7 a schematic section view of another embodiment of a second bearing row of the rolling bearing according to the invention,

FIG. 8 a schematic section view of another embodiment of a second bearing row of the rolling bearing according to the invention,

FIG. 9 a schematic section view of another embodiment of a first or second bearing row of the rolling bearing according to the invention, and

FIG. 10 another schematic section view through the rolling bearing according to the invention with a first and a second bearing row in which the two bearing rows are arranged one above the other.

### DETAILED DESCRIPTION OF THE PREFERRED EMBODIMENTS

For elements of the invention that are identical or have identical function, the same reference symbols are used. Furthermore, for the sake of a clear view, only reference symbols that are required for describing a particular figure are shown in that figure. The illustrated embodiments are only examples of how the rolling bearing according to the invention can be equipped and thus do not represent a definitive restriction of the invention.

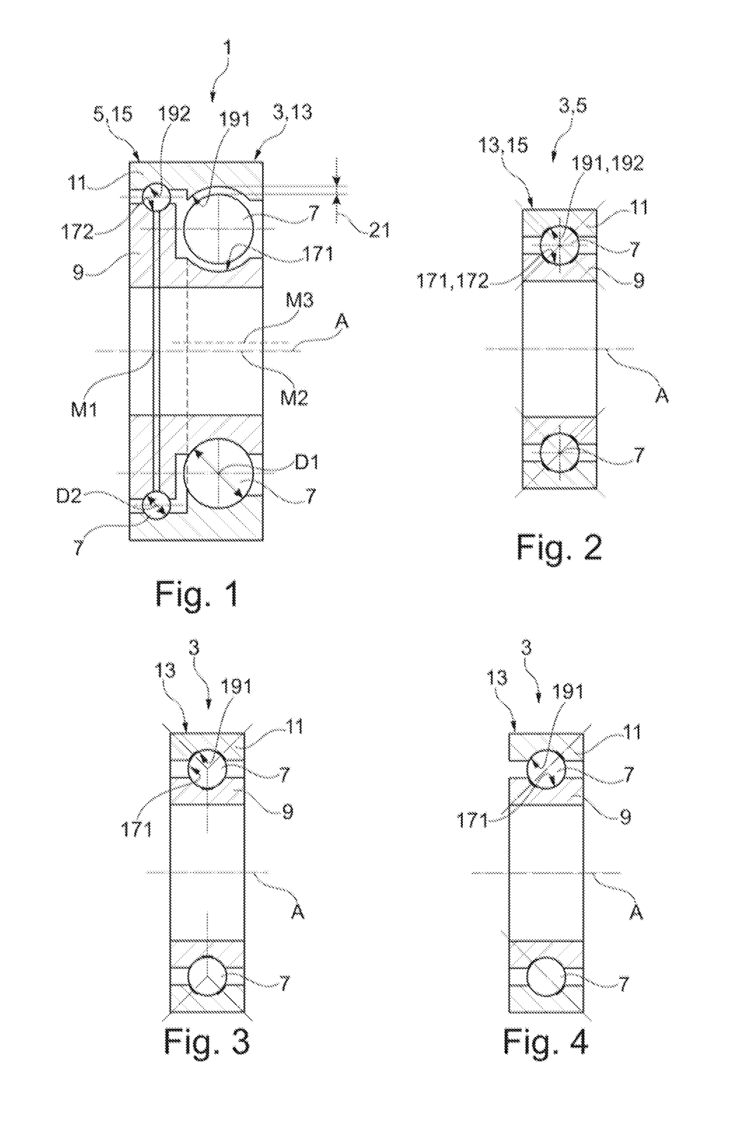

FIG. 1 shows a schematic section view through the rolling bearing 1 according to the invention with an inner ring 9 and an outer ring 11, wherein, between the inner ring 9 and the outer ring 11, multiple rolling bodies 7 of a first bearing row 3 are allocated between an inner ring raceway 171 and an outer ring raceway 191 allocated to the first bearing row 3 and multiple rolling bodies 7 of a second bearing row 5 are allocated between an inner ring raceway 172 and an outer ring raceway 192 allocated to the second bearing row 5. According to the invention, the first bearing row 3 is constructed such that, for a stationary inner ring 9 or outer ring 11, multiple rolling bodies 7 have a distance 21 to the inner ring raceway 171 or outer ring raceway 191 of the bearing row 3.

This has the effect that, for a rotating inner ring 9, the inner ring raceway 171 or the outer ring raceway 191 of the first bearing row 3 defines a raceway center point M2 and the inner ring raceway 172 or the outer ring raceway 192 of the second bearing row 5 defines a raceway center point M1, which both coincide with a rotational axis A of the rolling bearing 1 and wherein, for a stationary inner ring 9, the inner ring raceway 171 or the outer ring raceway 191 of the first bearing row 3 defines a raceway center point M3 that is radially offset relative to the raceway center point M1 of the second bearing row 5. Advantageously, this is achieved in that the inner ring 9 and the outer ring 11 of the first bearing row 3 are arranged relative to each other such that a bearing gap, a loose fit, or the like determines the distance.

Likewise, it is also conceivable, however, that instead of the previously described construction, an identical effect is achieved in that the outer ring raceway 191 of the stationary outer ring 11 of the first bearing row 3 has an elliptical shape, so that the distance 21 is determined.

Furthermore, for this embodiment shown in FIG. 1 it is provided that at least one of multiple rolling bodies 7 of the second bearing row 5 has a not shown oversize, so that the second bearing row 5 is pretensioned. The second bearing row 5 is here a single-row four-point bearing 15, wherein other embodiments can also provide another bearing 15 of a second bearing row 5. The first bearing row 3 is, in this embodiment, also a single-row radial ball bearing 13. It is also conceivable, however, that the first bearing row 3 is a multiple-row radial ball bearing or a single-row or multiple-row radial rolling bearing 13. Due to the fact that the first bearing row 3 is not at all or only slightly pretensioned based on the above description, for use as a wheel bearing in a vehicle, the rolling bearing 1 can absorb mainly the weight forces produced from the vehicle weight. The second bearing row 5 then mainly absorbs the tipping moments produced from the lateral forces when driving in a curve. In particular, the pretensioning of the second bearing row 5 is used to prevent slip damage and to prevent increases in friction that are too high when starting to drive in a curve.

As shown here, the rolling bearing 1 according to the invention can also be constructed such that a rolling body diameter D2 of the second bearing row 5 is less than a rolling body diameter D1 of the first bearing row 3. Thus, for the rotating inner ring 9, the first bearing row 3 then defines a raceway center point M2 and the second bearing row 5 also defines a raceway center point M1, which both coincide with a rotational axis A of the rolling bearing 1.

FIG. 2 shows a schematic section view of another embodiment of a first or second bearing row 3, 5 of the rolling bearing 1 according to the invention. Here, the first or second bearing row 3, 5 is a single-row four-point bearing 13, 15. In an embodiment as the second bearing row 5, the single-row four-point bearing 15 is then pretensioned. Thus, for example, at least one of the multiple rolling bodies 7 of the second bearing row 5 then has a not-shown oversize.

FIGS. 3 and 4 show schematic section views of additional embodiments of a first bearing row 3 of the rolling bearing 1 according to the invention. In the embodiment according to FIG. 3, the first bearing row 3 is a single-row three-point ball bearing 13. In the embodiment according to FIG. 4, the first bearing row 3 is a single-row angled contact ball bearing 13.

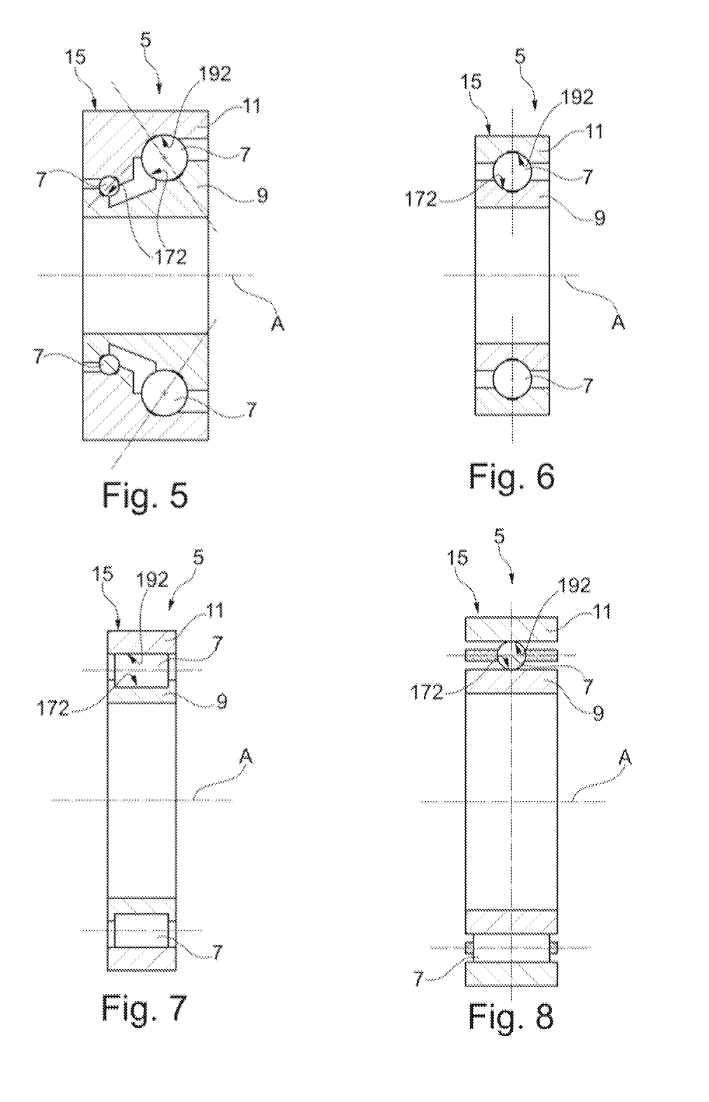

FIGS. 5 to 8 show schematic section views of additional embodiments of a second bearing row 5 of the rolling bearing 1 according to the invention. In the embodiment according to FIG. 5, the second bearing row 5 is a pretensioned two-row angled contact ball bearing 15. In the embodiment according to FIG. 6, the second bearing row 5 is a pretensioned single-row radial ball bearing 15. Furthermore, as shown in another embodiment in FIG. 7, the second bearing row 5 is, for example, a pretensioned single-row radial roller bearing 15. In the embodiment according to FIG. 8, the second bearing row 5 is a pretensioned, combined radial roller ball bearing 15.

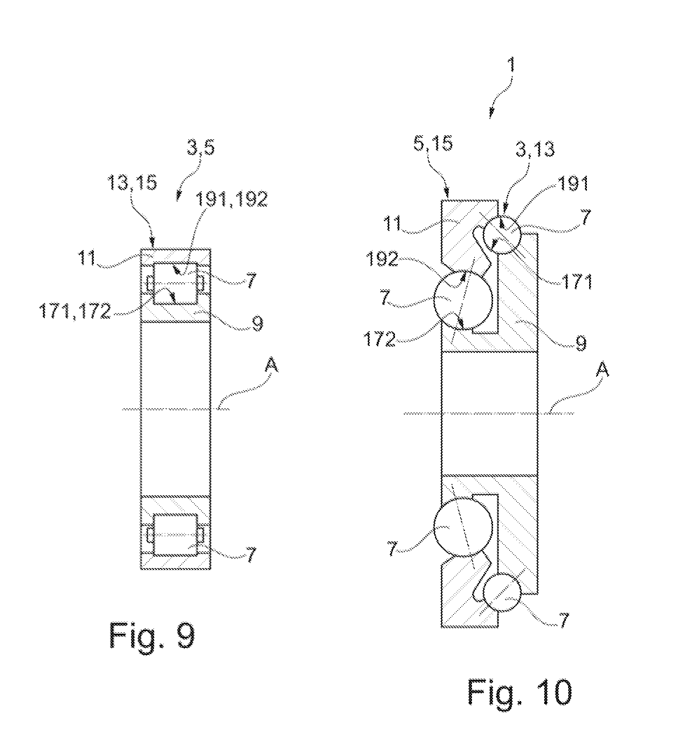

FIG. 9 shows a schematic section view of another embodiment of a first or second bearing row 3, 5 of the rolling bearing 1 according to the invention. Here, the first or second bearing row 3, 5 is a single-row spherical roller bearing 13, 15, wherein for an embodiment as a second bearing row 5, the single row spherical roller bearing 15 is pretensioned.

FIG. 10 shows another schematic section view through the rolling bearing 1 according to the invention with a first and a second bearing row 3, 5, in which, in this embodiment, the two bearing rows 3, 5 are arranged one above the other. All reference symbols shown here, as well as their effect, have already been described for FIG. 1, so that another description will not be repeated here.

### LIST OF REFERENCE NUMBERS

1 Rolling bearing
3 First bearing row
5 Second bearing row
7 Rolling body
9 Inner ring
11 Outer ring
13 Bearing of the first bearing row
15 Bearing of the second bearing row
171 Inner ring raceway of the first bearing row
172 Outer ring raceway of the second bearing row
191 Inner ring raceway of the first bearing row
192 Outer ring raceway of the second bearing row
21 Distance
A Rotational axis
D1 Rolling body diameter of the first bearing row
D2 Rolling body diameter of the second bearing row
M1 Raceway center point of the inner ring raceway or the outer ring raceway for a rotating or stationary bearing ring of the second bearing row
M2 Raceway center point of the inner ring raceway or the outer ring raceway for a rotating inner ring of the first bearing row
M3 Raceway center point of the inner ring raceway or the outer ring raceway for a stationary inner ring of the first bearing row

1. A rolling bearing comprising an inner ring, an outer ring, multiple rolling bodies of at least one first bearing row allocated between an inner ring raceway of the inner ring and outer ring raceway of the outer ring allocated to the first bearing row and multiple rolling bodies of at least a second bearing row are allocated between an inner ring raceway of the inner ring and an outer ring raceway of the outer ring allocated to the second bearing row,
the at least one first bearing row is constructed such that, for the inner ring being stationary or outer ring being stationary, the multiple rolling bodies have a distance to the inner ring raceway or to the outer ring raceway of the at least one first bearing row.

2. The rolling bearing according to claim 1, wherein, for the inner ring rotating, the inner ring raceway or the outer ring raceway of the at least first bearing row defines a second raceway center point (M2) and the inner ring raceway or the outer ring raceway of the at least second bearing row defines a first raceway center point (M1), which both coincide with a rotational axis (A) of the rolling bearing and wherein, for the inner ring being stationary, the inner ring raceway or the outer ring raceway of the at least one first bearing row defines a third raceway center point (M3) that is radially offset relative to the raceway center point (M1) of the at least second bearing row.

3. The rolling bearing according to claim 1, wherein the inner ring and the outer ring of the at least first bearing row are arranged relative to each other such that a bearing gap or a loose fit, determines the distance.

4. The rolling bearing according to claim 1, wherein the outer ring raceway of the stationary outer ring of the at least first bearing row is elliptical so that the distance is determined.

5. The rolling bearing according to claim 1, wherein the at least first bearing row is a single-row or multiple-row radial ball bearing or a single-row or multiple-row radial rolling bearing.

6. The rolling bearing according to claim 5, wherein the single-row or multiple-row radial ball bearing is a four-point, three-point, or angled contact ball bearing or the single-row or multiple-row radial rolling bearing is a cylinder roller, needle, spherical, or ball joint bearing.

7. The rolling bearing according to claim 1, wherein the at least second bearing row is axially pretensioned.

8. The rolling bearing according to claim 7, wherein at least one of the multiple rolling bodies of the at least second bearing row has an oversize, so that the at least second bearing row is pretensioned.

9. The rolling bearing according to claim 8, wherein the at least second bearing row is a four-point bearing, a two-row angled contact ball bearing, a single-row or multiple row radial ball bearing, a spherical or ball joint bearing, or a combination of a roller and radial ball bearing.

10. The rolling bearing according to claim 1, wherein a rolling body diameter (D2) of the at least second bearing row is less than a rolling body diameter (D1) of the at least first bearing row.
